(19) United States
(12) Patent Application Publication
(10) Pub. No.: US 2007/0141205 A1
(43) Pub. Date: Jun. 21, 2007

(54) Method of preparing pizza

(76) Inventor: Bernard D. Sadow, Chappaqua, NY (US)

Correspondence Address: ABELMAN, FRAYNE & SCHWAB, 666 THIRD AVENUE, 10TH FLOOR, NEW YORK, NY, 10017, US

(21) Appl. No.: 11/644,585

(22) Filed: Dec. 21, 2006

Related U.S. Application Data
(60) Provisional application No. 60/753,159, filed on Dec. 21, 2005.

(51) Int. Cl. A21D 13/00

(52) U.S. Cl. 426/94

(57) ABSTRACT

A method of preparing pizza pies includes providing a preformed flattened pizza dough shell of a desired shape on an appropriate cooking surface. A cheese topping is added to cover the shell and form the pizza pie. Additional toppings can be added before or after the cheese topping. The uncooked pizza pie is cut into a plurality slices that are separated a predetermined distance from each other. The pizza pie is cooked in an oven until the cheese topping flows along the edges of the slices and turns a brownish color. The pizza is then removed from the oven for consumption.

### FIELD OF INVENTION

The present invention relates to a method of making a pizza, and more specifically a method of cooking the pizza to enhance the taste and texture of the toppings on the pizza.

### BACKGROUND OF THE INVENTION

A pizza pie is conventionally made by flattening dough of a predetermined size into a shell and forming a thickened edge or raised portion at the perimeter of the flattened dough. Various toppings such as tomato sauce, cheese, meats and/or vegetables can be distributed on the upper surface of the shell. The pizza is placed in an oven and baked for a predetermined time and temperature to heat and cook the pizza. Once the pizza is cooked, the pizza is removed from the oven and typically cut into similarly size slices for consumption.

Preferably, the pizza pie is allowed to cool for a predetermined period prior to cutting the pie into the slices. However, restaurants that are busy or consumers who are hungry may hastily cut the pizza while the pie is still hot. Cutting the pie into slices while the pie is very hot can cause the toppings to slide off the upper surface of the shell. For example, cutting a hot pizza pie into slices often causes the cheese topping to cling to the cutter and become stringy, which in turn draws large portions of the cheese and other toppings off of the slices. Thus, some of the cheese and toppings are lost or displaced during the slicing process, thereby diminishing the appetizing appearance of the pizza pie.

### SUMMARY OF THE INVENTION

A method of preparing pizza pies includes providing a preformed flattenede pizza dough shell of a desired shape on an appropriate cooking surface. A cheese topping is added to cover the shell and form the pizza pie. Additional toppings can be added before or after the cheese topping. The uncooked pizza pie is cut into a plurality slices that are separated a predetermined distance from each other.

The pizza pie is cooked in an oven until the cheese topping flows along the edges of the slices and turns a brownish color. The pizza is then removed from the oven for consumption.

### BRIEF DESCRIPTION OF THE DRAWINGS

FIG. 1 depicts a top view of a pizza pie with a cheese topping cut into a plurality of slices prior to cooking;

FIG. 2 depicts the pizza pie of FIG. 1 with the plurality of slices separated from each other prior to cooking;

FIG. 3 depicts the pizza pie of FIG. 2 with the cheese topping formed at the edges of each of the plurality of slices after cooking;

FIG. 4 depicts the pizza pie of FIG. 3 having additional toppings formed on top of each of the plurality of slices; and

FIGS. 5A and 5B collectively depict a flow diagram of a method for preparing a pizza pie in accordance with the principles of the present invention.

To facilitate understanding of the invention, the same reference numerals have been used, when appropriate, to designate the same or similar elements that are common to the figures.

### DETAILED DESCRIPTION OF THE INVENTION

The present invention is a method for preparing a pizza pie to enhance the taste and texture of the cooked and melted cheese topping distributed over the upper surface of the pizza shell. The present invention is described in terms of a round shaped pizza pie; however, one skilled in the art will appreciate that any pizza pie that can be cut into a plurality of slices is within the scope of the present invention.

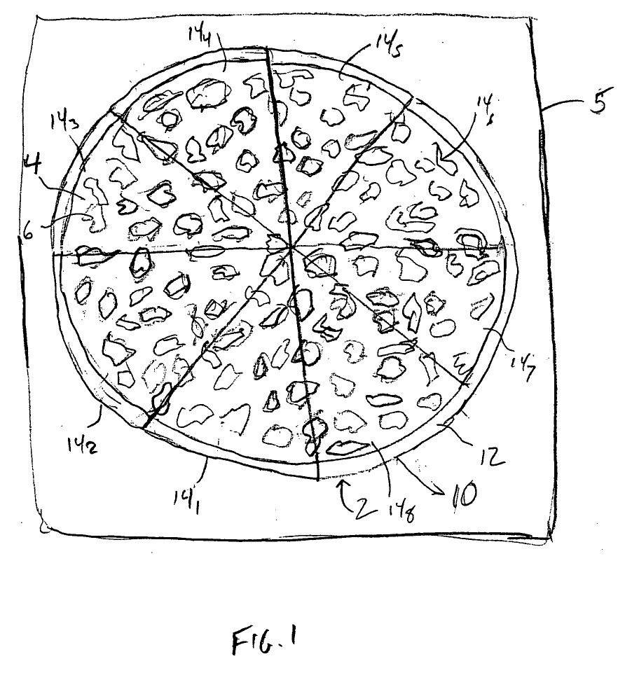

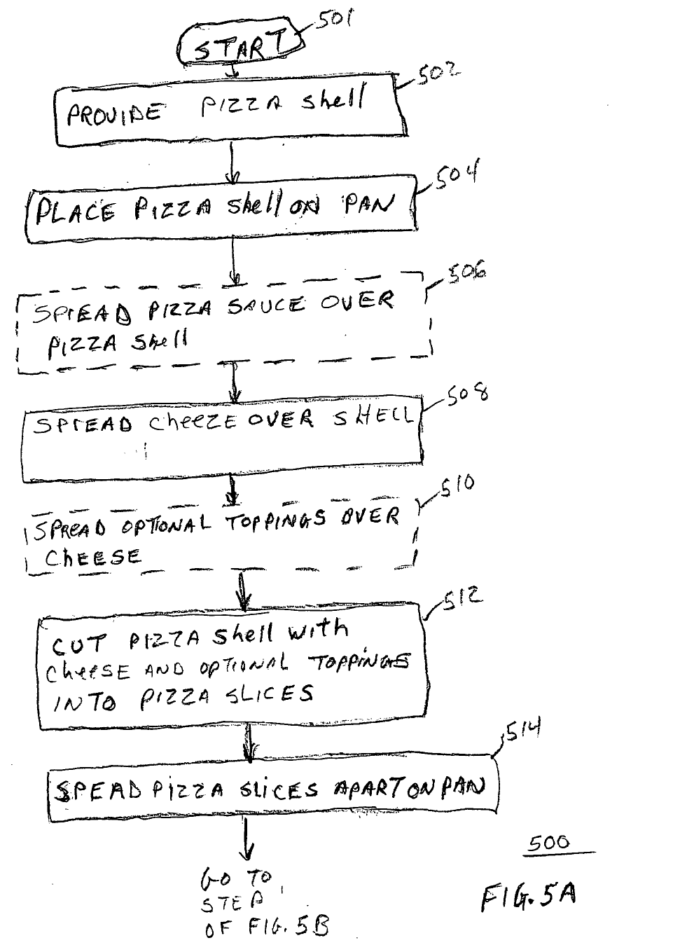

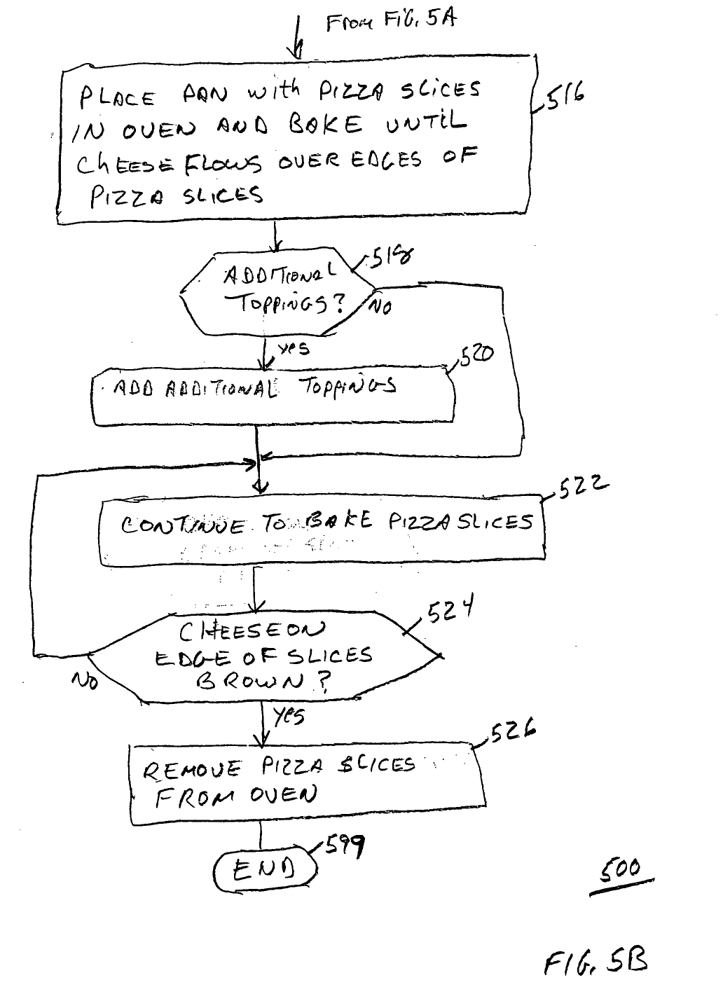

The FIGS. 1-4 depict various views of a pizza pie as it is being prepared and cooked in accordance with the method 500 presented in the flow diagrams of FIGS. 5A and 5B. Referring to FIG. 5A, the present process starts at step 501, where a person, such as a professional or amateur chef, a person cooking at home, or any other person preparing and cooking a pizza pie (hereinafter “chef”), assembles the ingredients to prepare the pizza, such as uncooked dough or a prepared pizza pie shell, tomato sauce, cheese, and other assorted toppings as desired.

At step 502, the chef forms the pizza shell by flattening out the dough, illustratively by using a roller, hand tossing, or other conventional method to form the pizza shell 10. One skilled in the art will appreciate that the uncooked pizza shell may take on any configuration and may include, but is not limited to, pizza shells having the traditional crust formed along the perimeter of the shell, a pan style pizza or a thin crust style pizza, all of which are well known in the art. For purpose of the illustration, the uncooked shell 10 is of the hand tossed traditional crust style. One skilled in the art will appreciate that a commercial or pre-formed shell of the type available in supermarkets can also be used in the practice of the invention.

At step 504, the flattened pizza shell is preferably placed on a cooking surface, such as a flat pan 5 having a size appropriate to support the bottom surface of the pizza shell, and the separated slices, as will be described in detail below. Preferably the pan 5 is a non-stick type pizza pan, although this type of flat pan should not be considered as limiting.

For example, the pan 5 can be a flat rim pan, a straight sided pan, a rectangular pan, a square cutter pan, a flat shovel pan, a flat cookie sheet, aluminum foil, ceramic dish or plate, or any other substantially flat surface, with or without a rim, suitable for cooking moving a pizza pie.

Optionally, at step 506, pizza sauce is spread over the pizza shell in a conventional manner, such as by using a ladle, large spoon, and the like. The pizza sauce can be any tomato-based sauce as conventionally known in the culinary art.

At step 508, a cheese topping, such as mozzarella cheese, is distributed over the top surface of the shell, and where the pizza sauce was provided at step 506, then the cheese is spread over the sauce, as conventionally known in the art. Typically the tomato sauce is spread as a thin layer over the entire surface of the pizza shell, and the cheese is distributed over portions of the tomato sauce. However, one skilled in the art will appreciate that steps 504 and 506 can be performed in reverse order, so that the cheese is initially spread over the shell 10, followed by the sauce being spread over the cheese and shell.

At step 510, one of more additional toppings can be optionally distributed over the cheese on the shell. The toppings can be any conventional meat, vegetable or fruit topping, such as pepperoni, sausage, onions, mushrooms, peppers, pineapple, and the like.

At step 512, the pizza pie with its cheese and optional toppings are cut into a plurality of slices. For example, a substantially circular pizza pie is typically cut into six (6) or eight (8) substantially even sized slices by using a cutting wheel, knife, or other suitable cutting utensil.

Referring to FIG. 1, the uncooked pizza pie 2 is placed on the flat pan 5, and is illustratively shown having a layer of sauce 4 and the cheese 6 evenly distributed over the upper surface of the shell 10.

Further, the uncooked pizza pie 2 is illustratively cut into eight (8) similarly sized slices, collectively slices 14. In particular, each slice 14 has a plurality of edges 16. For the traditional triangular shaped slices, each slice 14 has two opposing edges 16₁ and 16₂ which are angularly displace from each other and meet at an apex 18.

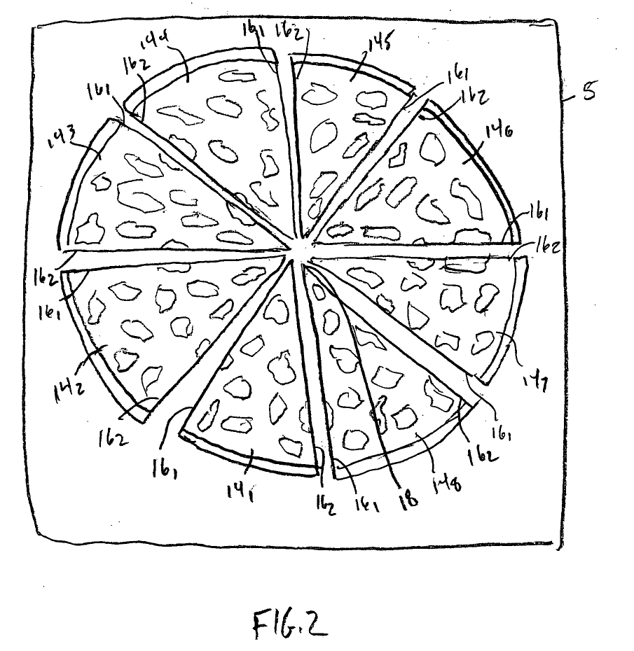

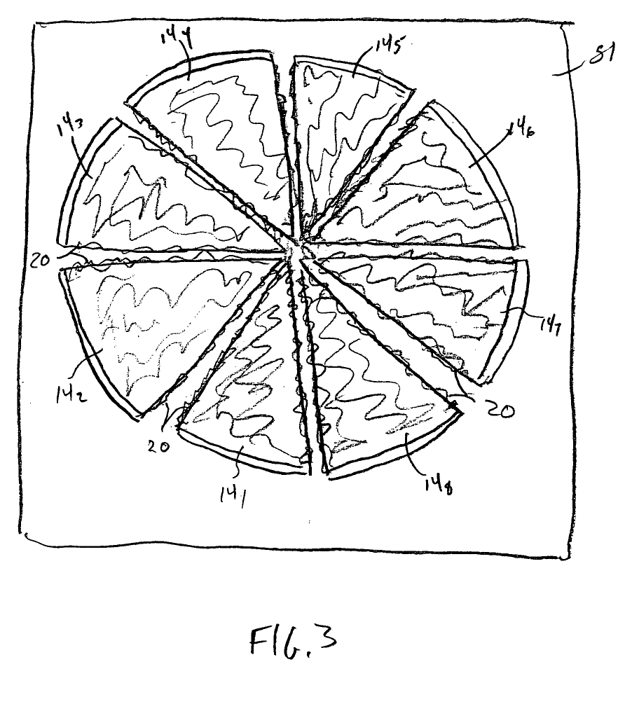

Referring to FIG. 2, along with step 514 of FIG. 5a, the slices 14 are spread apart from each other on the cooking surface of the pan 5. The slices are spread apart a distance to allow the cheese to flow over the edges 16 of the slices, as described below with respect to FIGS. 3-5.

Preferably, the slices are separated a distance such that the edge of an opposing slice will help prevent the melted cheese from flowing too far away from the edge of the slices where the cheese originated, for example, in case of over heating during cooking. In one embodiment, the slices are spread apart from each other approximately ¼ to ½ of an inch, although such distances are not to be considered as limiting. For example, edge 16₁ of slice 14₁ is separated approximately ¼ to ½ of an inch from edge 16₂ of slice 14₂, edge 16₁ of slice 14₂ is separated approximately ¼ to ½ of an inch from edge 16₂ of slice 14₃, edge 16₁ of slice 14₃ is separated approximately ¼ to ½ of an inch from edge 16₂ of slice 14₄, and so forth.

At step 516, the uncooked pizza pie 2 is now ready for cooking. In one embodiment, the pan with the pizza slices 14 is placed in an oven and baked until the cheese flows over the edge 16 of the pizza slices.

Alternatively, the pizza slices 14 can be prepared, for example, on an oven peel (e.g., wooden or metal pizza oven peel or other shovel-like tool) and slid in an oven or other cooking surface without the pan. That is, the slices can be heated and cooked directly on the cooking surface of the oven and the like, as opposed to being placed the top surface of a pan that is placed in the oven. One skilled in the art will appreciate that the uncooked pizza pie slices 14 can be cooked by any other appliance, such as a microwave oven, toaster oven, broiler, among other conventional cooking devices that are capable of cooking the pizza until the cheese melts and the optional toppings are considered “cooked,” as desired.

In one embodiment, the uncooked pizza pie is placed in the oven and baked at a temperature in the range of 300° F. to 500° F. for a time in a range of 5 to 20 minutes. Preferably, the pizza pie slices 14 are cooked so that the layer of sauce applied to the pizza remains in a moist state and does not become coagulated, dried or hardened, and the cheese layer melts and flows over the edges 16 of the slices 14 proximate the upper surface of the pan 5.

Referring to FIG. 3, the cheese is shown as having melted and flowed proximate and over at least portions of the edges 16 of the slices 14. Depending on the amount of cheese 6 distributed on the slices, the melting cheese 20 will flow over portions of the edges 16 of the slices towards the pan 5.

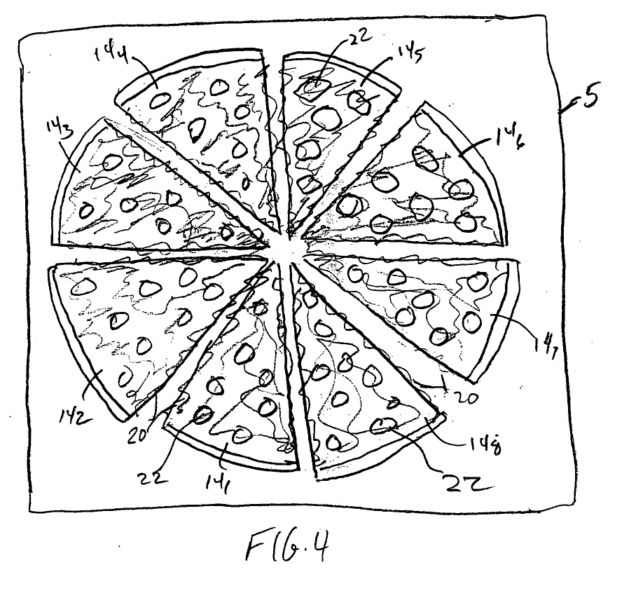

At step 518, the chef determines whether additional toppings are desired to be distributed over portions or the entire surface of the pizza pie slices 14. Referring to FIG. 4, if additional toppings 22 are desired, then at step 520 the additional toppings 22 are applied to the top of the slices 14 and the method 500 proceeds to step 522, where the pizza pie 2 with the additional toppings 22 are placed back into the oven for further cooking. Thus, the pizza pie 2 is baked twice.

If at step 518 no additional toppings are to be added to the pizza pie 2, then the method 500 proceeds to step 522 where the pizza pie continues to bake in the oven. At step 524, the chef monitors the cheese at the edges of the slices to determine whether the cheese has turned a brownish color, and optionally, has a crispy texture. If at step 524 the melted cheese 20 on the edges 16 of the slices 14 has not turned a brownish color, then the chef continues to allow the pizza pie 2 to bake in the oven.

Once the melted cheese 20 on the edges 16 of the slices 14 turns a brownish color, and optionally has a crispy texture, the chef removes the pizza slices from the oven, at step 526, by removing the pan 5 from the oven. The brownish color (and optionally crispy texture) of the cheese along the edges of the slices 14 indicates that the pizza is now fully cooked.

The method then proceeds to step 599, where the sliced pizza pie is removed from the oven by withdrawing the pan 5 from the oven. Accordingly, since the pizza pie 2 has already been cut into individual slices 14, the chef can easily distribute the slices from the pan 5 to a plate to be served to friends, family, or customers for consumption.

Advantageously, the present invention enables a chef to improve the taste of the pizza by allowing the cheese along the edges of the individual slices to cook until they turn a brownish color, which indicates that the cheese will have a slightly roasted taste. The roasting of the cheese along the edges of the slices adds additional flavors typically deemed desirable. Further, many pizza “connoisseurs” can now enjoy their pizza with the melted cheese having a crispy texture formed along the edges of the slices.

One skilled in the art will appreciate that the order of adding the toppings over the shell is not to be considered as limiting. That is, the cheese, and any other sauce or toppings can be placed on the shell in any sequence. Additionally, one skilled in the art will appreciate that any other non-cheese toppings that are positioned along the edge of a slice will also turn a brownish color and/or become crispy in their texture.

By pre-slicing the uncooked pizza into a plurality of slices 14 prior to cooking the pizza pie; the chef avoids the undesirable consequence of disturbing the cheese layer while cutting the pizza pie into slices with a cutting utensil when the pizza is removed hot out of the oven.

Accordingly, the cheese does not become stringy and pull away from the top of the pizza, as is the case in the prior art when cutting the pie into slices while the pizza pie is very hot. Therefore, the pre-cut slices are much more appealing to look at when being served, since the cheese is not stringy and additional toppings are not clumped in one location on a slice or pulled off the slice, thereby making each slice easier to eat by hand.

Although various embodiments that incorporate the teachings of the present invention have been shown and described in detail herein, those skilled in the art can readily devise many other varied embodiments that are within these teachings and the scope of the invention is to be determined with reference to the claims that follow.

I claim:

1. A method for preparing a pizza pie, comprising:
providing a preformed flattened pizza dough shell;
adding a cheese topping over an upper surface of the shell to form said pizza pie;
cutting the pizza pie into a plurality of uncooked slices each having a plurality of edges;
separating said plurality of uncooked slices a predetermined distance;
cooking said pizza pie in an oven until said cheese topping flows along the edges of said slices and turns a brownish color; and
removing said pizza pie from said oven for consumption.

2. The method of claim 1 further comprising, adding at least one additional topping over the shell prior to cutting said pizza pie into slices.

3. The method of claim 2, wherein said at least one additional toppings is added prior to addition of said cheese topping.

4. The method of claim 2, wherein said at least one additional topping is added after addition of said cheese topping.

5. The method of claim 2, wherein said at least one additional topping is selected from the group consisting of a vegetable topping, tomato sauce, a meat topping, and a fruit topping.

6. The method of claim 1, wherein the separation of said plurality of slices a predetermined distance comprises separating said slices a distance in a range of approximately one-quarter to one-half of an inch apart from each other.

7. The method of claim 1, further comprising placing said flattened dough on a substantially flat cooking surface prior to cutting said pizza pie into a plurality of slices.

8. The method of claim 7, wherein said cooking said pizza pie in an oven comprises cooking said plurality of slices on said flat cooking surface.

9. The method of claim 7, wherein said removing said pizza pie is removed from the oven on the cooking surface.

10. The method of claim 1, wherein said cooking step further comprises:
adding at least one additional topping to one or more slices after said cheese topping flows along the edge.

11. The method of claim 1, wherein said cooking step further comprises cooking said pizza pie until the cheese along the edges of said slices has a crispy texture.
